(19) United States
(12) Patent Application Publication
(10) Pub. No.: US 2004/0208955 A1
(43) Pub. Date: Oct. 21, 2004

(54) Monovalent salt enhances solubility of milk protein concentrate

(76) Inventors: Alistair Carr, Palmerston North (NZ); Vijaya Bhaskar, Palmerston North (NZ); Satyendra Ram, Fitzherbert West (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/479,401

(22) PCT Filed: May 31, 2002
(86) PCT No.: PCT/NZ02/00105

(30) Foreign Application Priority Data
May 31, 2001 (NZ) 512098
Jun. 8, 2001 (NA) 512281

(51) Int. Cl. A23C 9/12

(52) U.S. Cl. 426/34

(57) ABSTRACT

The invention provides a dried enhanced-solubility milk protein concentrate (MPC) containing at least one monovalent salt added prior to drying. Methods for preparing this product are provided. These include a method comprising (a) providing an MPC having at least 70% dry matter as milk protein in aqueous solution/suspension (b) adding at least one monovalent salt in an amount that confers enhanced solubility on the product when dried and (c) drying the product. The enhanced-solubility MPC may be used in cheese manufacture.

### TECHNICAL FIELD

This invention relates to milk products, processes for their preparation and use, particularly in cheese manufacture.

### BACKGROUND ART

A “milk protein concentrate” (MPC) is a milk protein product in which greater than 55%, preferably greater than 75%, of the dry matter is milk protein and the ratio of casein to whey proteins is approximately that of milk. Such concentrates are know in the art. MPCs are frequently described with the % dry matter as milk protein being appended to “MPC”. For example MPC70 is an MPC with 70% of the dry matter as milk protein.

The term “milk protein isolate” (MPI) refers to a milk protein composition comprising a substantially unaltered proportion of casein to whey proteins wherein the dry matter consists of greater than 85% milk protein. Such isolates are known in the art.

These products differ from milk concentrates in that they are high in protein and low in fat and lactose. They differ from skim milk concentrates in that they are high in protein and low in lactose.

One use for MPC and MPI is in cheese manufacture, By addition of these to increase the protein concentration of milk used in the manufacture of cheese, cheese making can be made more consistent and more efficient.

Using evaporation and drying, it is possible to obtain died MPC and MPI. The key problem in manufacturing a dried high protein milk protein concentrate is that such products are generally very insoluble at cold temperatures, This particularly a problem where the milk protein content is 85% or more. However even at milk protein contents as low at 70% it is also a problem. In addition the solubility at all temperatures declines on storage.

Also these dried products suffer from the disadvantage that they are associated with the formation of nuggets in the cheese. Nuggets ate thin protein gels of a different colour in the cheese. Nugget formation is consistently a problem when dried MPI with 85% dry matter as milk protein is used.

Nugget formation occurs on some but not all occasions when a dried MPC with 70% dry matter as milk protein is used. These problems can be overcome by use of elevated temperatures after mixing the dried MPC or MPI with the milk. However, this adds an extra step to the cheese manufacturing process.

WO 01/41578 describes methods for preparing dried MPC or MPI using calcium removal by one of (1) use of a cation exchanger (2) acidification and dialysis and (3) chelation. However a need for a simple method for preparing dried MPC and MPI with good solubility properties remains as these methods involve either extra processing steps or addition of chelating agents.

An object of the present invention is to provide an improved method for preparing a dried milk protein product with enhanced solubility properties and/or a reduced tendency to cause nugget formation in cheesemaking without the need for use of cation exchange, acidification or addition of chelation agents, or at least to provide the public with a useful choice.

### DISCLOSURE OF THE INVENTION

In one aspect, the invention provides a method for preparing a dried enhanced-solubility MPC or MPI product comprising:

(a) providing an MPI or MPC having at least 70% dry matter as milk protein in aqueous solution/suspension;

(b) adding at least one monovalent salt in an amount that confers enhanced solubility on the product when dried; and

(c) drying the product.

Preferably between salt addition and drying steps, this process and other processes of the invention include a dewatering step, preferably using evaporation.

The term “enhanced-solubility” refers to the property of a product which on reconstitution into a 5% w/v solution provides less sediment on centrifugation for 10 minutes at 700g relative to the corresponding product without salt treatment. For example the enhanced-solubility may be solubility at 20° C. where there is less than 5% sediment on centrifugation at 10 minutes at 700 g.

Additionally or altematively the enhanced solubility may be demonstrable at a range of temperatures below 60° C. In some cases the enhanced solubility will be enhanced solubility following storage. That particular property may not be readily measurable mediately after manufacture but becomes apparent subsequently.

In another aspect the monovalent or divalent salt is added directly to the skim milk used to prepare the MPI or MPC. Thus the invention provides a method for preparing a dined enhanced solubility MPC or MPI product comprising:

(a) providing a skim milk in the form of an aqueous solution/suspension;

(b) adding at least one monovalent salt;

(c) concentrating the solution obtained by ultrafiltration, optionally with diafiltration to form an MPI or MPC having at least 70% dry weight as protein and

(d) drying to prepare a dried product with enhanced solubility.

In the process of this aspect of the invention, the amount of salt used is greater to allow for loss during ultrafiltration and any diafiltration. This maybe calculated so that the ratio of added salt to protein at the time of drying is equivalent to that in the first aspect of the invention at the same stage.

In a further aspect the monovalent salt is added during diafiltration. Thus there is provided a method of preparing a dried enhanced-solubility MPC or MPI comprising:

(a) providing a skim milk solution in the form of an aqueous solution/suspension;

(b) concentrating the skim milk by ultrafiltration, with diafiltration, to form an MPI or MPC having at least 70% dried weight as protein;

(c) drying to prepare a dried product with enhanced solubility;

wherein the diafiltration medium comprises at least one monovalent salt. Again, the ratio of added salt to protein at the time of drying may be calculated to be the same to that in the first aspect of the invention.

In a further aspect, the monovalent salt is added to the MPC or MPI during or after a dewatering step which reduces the water content of the MPI or MPC, but does not dry the product. Thus there is provided a method for preparing a dried enhanced-solubility MPC or MPI comprising:

(a) providing an MPI or MPC having at least 70% dry matter as milk protein in aqueous solution/suspension;

(b) removing part of the water from the MPC or WI

(c) adding to the concentrated MPC or MPI at least monovalent salt in an amount that confers solubility on the product;

(d) drying the product

In a preferred embodiment the dewatering step is an evaporation step.

Common to each of the above aspects of tile invention is the addition of an edible monovalent salt. Preferred salts are sodium and potassium salts, preferably chlorides. Sodium salts are currently preferred, especially sodium chloride. Divalent salts may be added additionally, including calcium salts. Salts which may be used include Mg, Fe and Zn salts.

The MPC or MPI may be prepared by conventional methods using ultrafiltration optionally with diafiltration. The dewatering and doing steps may also be those conventionally used.

The starting material is preferably freshly prepared MPI or MPC in aqueous solution/suspension as opposed to being reconstituted and dried. However it is also possible to reconstitute MPC or MPI with poor reconstitution properties and use the method of the invention to improve its properties. Because of the poor reconstitution properties, reconstitution is carried out at temperature sufficient to solubilise it, for example 50° C. However following processing according to the invention improved solubility at lower temperature can be obtained.

By manipulating the choice of sodium or potassium, or the pH of the retentate post ultrafiltration and diafiltration, it is possible to vary the flavour of the product. Typically the pH used would be in the range 6.2-7.0. For some circumstances it will also be useful to provide micronutrient cations in addition to sodium or potassium.

The drying techniques used in the invention include thermal falling film evaporation and spray drying. Drying may be proceeded by dewatering.

The term “skim milk” includes skim milks which have undergone some pretreatment which does not substantially alter the proportions of casein to whey proteins.

An example of such a pretreatment would include for example a pH treatment or an ionic exchange treatment. However, skim milk particularly freshly prepared skim milk, is a preferred starting, material.

It is noted that the term “addition of a monovalent or divalent salt” includes methods of increasing the salt content indirectly, for example by addition of a base such as sodium hydroxide or potassium hydroxide following addition of a buffer, not itself composed of mono and divalent salts.

The amount of monovalent salt to be added is generally an amount which will provide an increase in the cation to protein ratio of 0.013-0.30 moles per 100 g protein, preferably 0.035-0.25 moles per 100 g protein, most preferably 0.035-0.10 moles per 100 g protein. For divalent salts the amount to be added is lower-0.004-0.15 moles per 100 g protein, preferably0.006-0.08 moles per 100 g protein.

The solubility properties of the products of the process of the invention make the resulting dried MPC and MPI advantageous in the preparation of a variety of products. For example the increased solubility allows for more ease of use in incorporation into beverages. Also, the dried MPC and MPI of the invention may be advantageously used in cheese manufacture for avoidance of nugget formation.

It is noted that by changing the drying conditions one can make considerable changes to the solubility of the dried powder. In general a higher outlet temperature results in a decrease in solubility and a reduction in functional properties of the dried powder. It is recognised that through manipulation of the drying conditions one can enhance or reduce the effect that salt addition has on the functional properties of the powder produced.

### BRIEF DESCRIPTION OF DRAWINGS

FIG. 1 is a graph of cold water solubility of reconstituted MPC 85 manufactured with and without added sodium ions at a range of hydration times (with and without storage at 40° C. for 7 days).

●Fresh, added sodium; ∘Fresh, no added sodium;

▾Stored, added sodium; ΔStored, no added sodium

FIG. 2 is a graph of solubility of the MPC (over a range of reconstitution temperatures) manufactured in the larger scale trial with and without added sodium ions at a range of temperatures.

∘Fresh, added sodium; ●Fresh, no added sodium;

□Stored at 40° C. for 7 days, added sodium; ▪Stored at 40° C. for 7 days, no added sodium;

ΔStored at 40° C. for 1 month, added sodium; ▾Stored at 4⁰° C. for 1 month, no added sodium;

∘Control powder stored at 40° C. for 7 days and reconstituted in salt water

FIG. 3 shows electron micrographs of control and cation-enhanced MPC85 powders (0.045 mol sodium/100g protein) manufactured on a commercial plant that have been stored at 40° C. for differing lengths of time.

FIG. 4 shows the effect of storage at 40° C. on solubility of MPC85 powders with increasing concentrations of added cation (●-sample E (control); ●-sample F (0.06 moles/100 g protein); ▾-sample G (0.10 moles/100 g protein)) reconstituted in water at 20° C.

FIG. 5 shows the effect of storage at 40° C. on solubility of MPC85 powders with increasing concentrations of added cation (●-sample E (control); ▪-sample F (0.06 moles/100 g protein); ▾-sample G (0.10 moles/100 g protein)) reconstituted in water at 30° C.

FIG. 6 shows the effect of storage at 40° C. on solubility of DC85 powders with increasing concentrations of added cation (●-sample E (control); ▪-sample F (0.06 moles/100 g protein); Δ-sample G (0.10 moles/100 g protein)) reconstituted in water at 40° C.

FIG. 7 shows the effect of storage at 40° C. on solubility of MPC70 powders with increasing concentrations of added cation (●-sample J (control); ▪-sample I (0.06 moles/100 g protein); Δ-sample J (0.11 moles/100 g protein)) reconstituted in water at 20° C.

FIG. 8 shows the effect of storage at 40° C. (closed symbols fresh; open symbols 2 weeks storage) on solubility of MPC85 powders with (●-sample K) and without (▪-sample E) added sodium cations (0.030 moles/100 g protein) reconstituted in water over a range of temperatures.

FIG. 9 shows the effect of storage at 40° C. (closed symbols fresh; open symbols 2 weeks storage) on solubility of MPC85 powders with (●-sample L) and without (▪-sample E) added potassium cations (0.030 moles/100 g protein) reconstituted in water over a range of temperatures.

FIG. 10 shows the effect of storage at 40° C. (closed symbols fresh; open symbols 2 weeks storage) on solubility of MPC85powders with (●-sample M) and without (▪-sample E) added potassium cations (0.023 moles/100 g protein) reconstituted in water over a range of temperatures.

FIG. 11 shows the effect of storage at 40° C. (closed symbols fresh; open symbols 2 weeks storage) on solubility of MPC85 powders with (●-sample A) and without (▪-sample A) a mixture of added potassium cations (0.031 moles/100 g protein) and calcium cations (0.006 moles/100 g protein) reconstituted in water over a range of temperatures.

FIG. 12 shows the solubility/powder storage profiles of a commercial MPC85 powder (Δ) and the same commercial MPC85 powder that has been reconstituted at 50° C., had sodium and potassium cations added (total cation addition of 0.221 moles per 100 g ) and then redried (●) (Sample O-Table 1).

FIG. 13 is a schematic diagram of cation enhanced MPC manufacture.

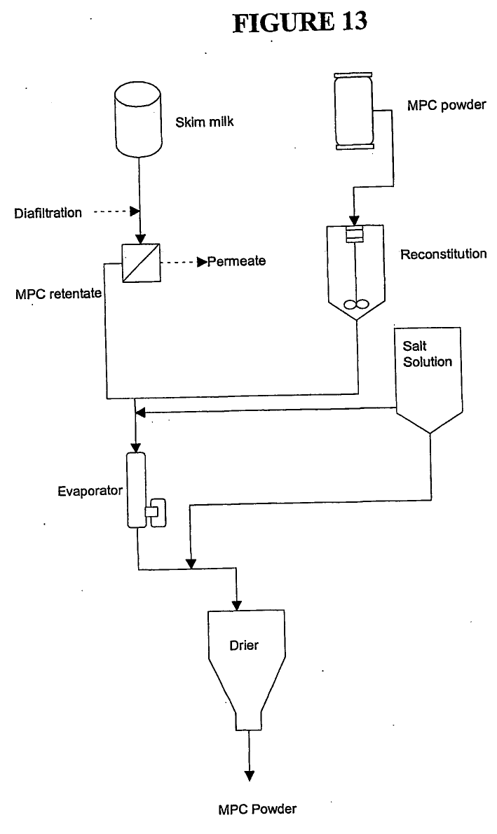

### EXAMPLES

The following examples further illustrate practice of the invention. Table 1 shows the amount of added cation for samples A-O described in the Examples.

TABLE 1
The added cation composition of the experimental MPG
powders described in the Examples.

| Powder type | Moles of cation added to MPC retentate (as chloride) | | |
|---|---|---|---|
| and sample ID | Na (moles/100 g protein) | K (moles/100 g protein) | Ca (moles/100 g protein) |
| (A) MPC85 | 0.05 | | |
| (B) Small- | | | |
| scale MPC85 | | | |
| control | | | |
| (C) Large- | 0.045 | | |
| scale MPC85 | | | |
| (D) Large- | | | |
| scale MPC85 | | | |
| control | | | |
| (E) Pilot-scale | | | |
| MPC85 | | | |
| control | | | |
| (F) Pilot-scale | 0.06 | | |
| MPC85 | | | |
| (G) Pilot-scale | 0.10 | | |
| MPC85 | | | |
| (H) Pilot-scale | | | |
| MPC70 | | | |
| control | | | |
| (I) Pilot-scale | 0.06 | | |
| MPC70 | | | |
| (J) Pilot-scale | 0.11 | | |
| 0 | | | |
| (K) Pilot-scale | 0.030 | | |
| MPC8S | | | |
| (L) Pilot-scale | | 0.030 | |
| MPC85 | | | |
| (M) Pilot-scale | | 0.023 | |
| MPC85 | | | |
| (N) Pilot-scale | | 0.031 | 0.006 |
| MPC85 | | | |
| (O) Small- | 0.081 | 0.140 | |
| scale MPC85 | | | |

### Example 1

### Small Scale Demonstration of Process

An MPC retentate is produced when skim milk is subjected to concentration on an ultrafiltration (or a microfiltration) membrane (Koch S4HFK 131 type membranes having a nominal molecular cut-off of 10,000 daltons) to produce an MPC retentate. Depending on the concentration actor used, the MPC retentate will have a protein content in the range of 42 to 85% of the dry matter as milk protein

Commercially manufactured MPC85 retentate (20% w/w total solids) from Anchor Products Hautapu New Zealand was obtained and split into two batches of 5 liters.

To one batch sodium ions, in the form of its chloride salt, were added to the retentate at the same protein:sodium ratio as found in s milk (005 moles sodium/100 g protein). 30.91 g of NaCl dissolved in 100 ml of deionised water was added to 5 liters of retentate and mixed at 40° C. for 90 minutes.

The second batch was used as a control. To the control batch (5 lies of retentate) 100 ml of deionised water was added and mixed at 40° C. for 90 minutes.

Both batches of retentate were dried on a laboratory spray drier. The drier operating parameters were: inlet air temperature 190°, outlet air temperature 90° C.

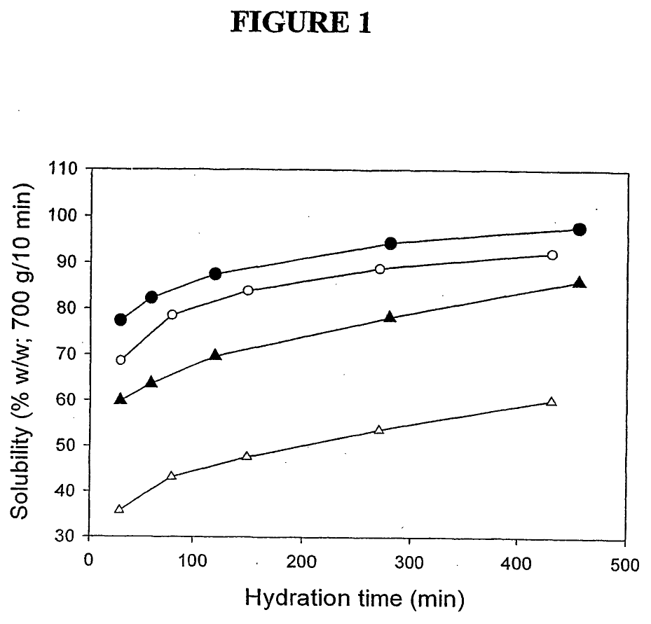

The cold water solubility of the powder was determined at 20° C. A 5% w/w solution for each was prepared in cold water (20° C.). Samples were extracted 30, 60, 120,280 and 455 minutes of reconstitution and spun in a centrifuge at 700 g for 10 minutes. The total solids content of the supernatant from each sample was compared to the total solids of the bulk solution to give a percent solubility. This data was plotted to give the cold water solubility profile shown in FIG. 1. The cation-enhanced product (sample A-Table 1) was more soluble than the control (sample B-Table 1). The effect was more pronounced after storage for 7 days at 40° C. (see FIG. 1).

### Example 2

### Larger Scale Demonstration of the Process

A larger scale trail was conducted to manufacture 60 kg of MPC85 powder with al added salt (NaCl) to give a final added sodium concentration in the powder of 0.045 mol/100 g protein (sample C-Table 1) and 60 kg of control MPC85 with no salt addition (sample D-Table 1).

The trial was performed by pumping a brine solution (20% w/w NaCl) into MPC85 retentate prior to evaporation and drying. The addition of the brine solution diluted the retentate by about 0.5%. The brine solution had a contact time with the retentate in the pipe-work prior to the evaporator of about 5-10 minutes.

The powders were stored at 40° C. in sealed foil sachets. 40° C. is a temperature that powder can typically reach during transportation, particularly in the holds of ships and on wharves and in warehouses in warm climates. Deterioration reactions in powders happen at a faster rate at 40° C. than at lower temperatures. Time-scales for differences in powders at lower temperatures such as 20° C. will likely be an order of magnitude longer. According to Labuza (in An integrated approach to food chemistry: Illustrative cases. In Food Chemistry, Fenema, O. (ed). Pp 913-938, (1985)) a shelf life of 1 month at 40° C. can be equivalent to 18 months shelf life at 23° C. for dehydrated foods.

The temperature solubility profiles were obtained by mixing samples of the powders in water for 30 minutes at a range of temperature and then centrifuging at 700 g for 10 minutes. The solubility was determined by comparison of the supernatant total solids wit the bulk solution total solids as in Example 1.

The solubility profile of the powders made on large scale were somewhat different from the powders made on pilot plant scale and small scale. This difference is probably due to the use of different driers. No difference in solubility was detected between the solubility/temperature profiles of the fresh powder with added salt and the fresh control powder with no added salt.

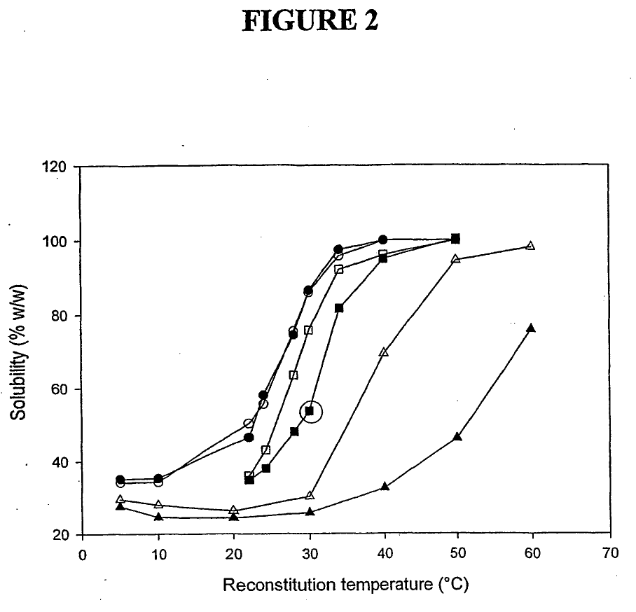

A difference was observed after the powders have been stored at 40° C. for 7 days with the cation-enhanced powder showing significant improvement in solubility compared to the control powder. The results are shown in FIG. 2.

After storing the powder at 40° C. for one month the difference is even more dramatic. For example at a reconstitution temperature of 50° C. the cation-enhanced powder has a solubility of 95% whereas the control powder has a solubility of less than 46%.

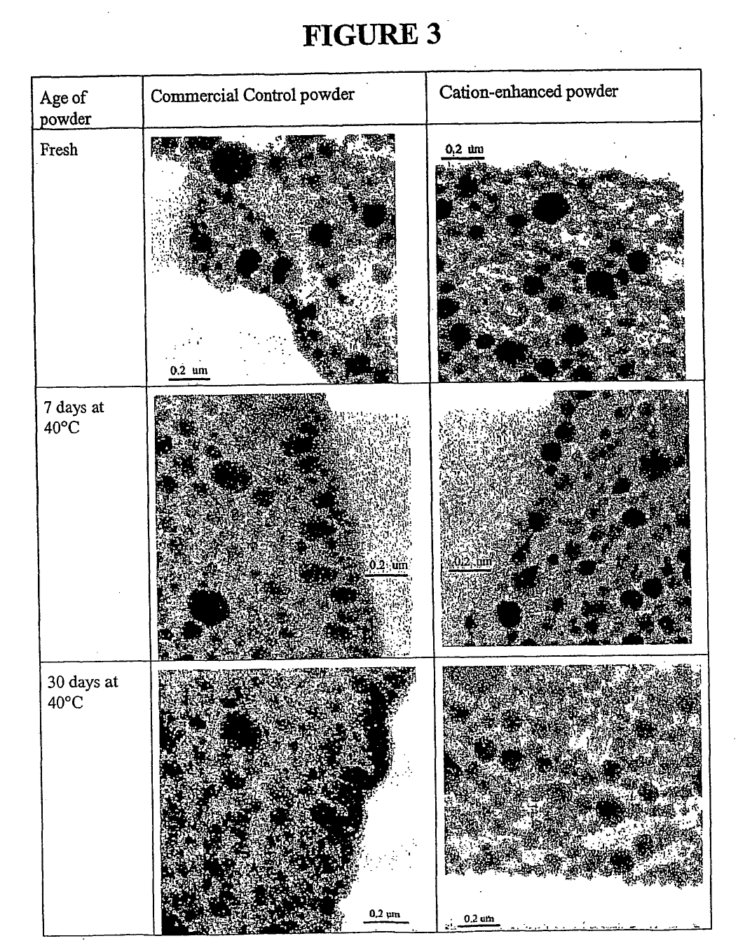

The transmission electron microscopy images shown in FIG. 3 also demonstrate the stability of the cation-enhanced powders. One can clearly see that the protein (stained black in the images) in the control powder changes on storage at 40° C. where as the morphology of the cation-enhanced powder remains constant. The implication of these images is that the protein in the cation-enhanced powders maintains its functional properties for longer than standard high protein powders.

The improved solubility on storage (even at large scale) will enable more consistent product to reach customers and affords the powder with more robustness with regard to temperature abuse during shipping and storage prior to use.

### Example 3

### Addition of Cations—Cations After the Drying Process

This experiment was carried out to determine if the improved solubility in the stored powder of Example 2 could be duplicated simply by adding salt to dried MPC85. A 10 g sample of the stored (7 days at 40° C.) control powder (sample D-Table 1) was dissolved in a 190 g solution (30° C.) containing the same amount of dissolved salt (0.2288 g) that would be added if 10 g of cation-enhanced powder were being dissolved. The composition of this control solution with added salt was therefore no different to a solution of cation-enhanced powder. The solubility of the stored control sample was no different dissolved in a salt solution (53.34% w/w) than it was dissolved in pure water (53.68% w/w), This experiment shows that surprisingly the addition of salt prior to drying is necessary to confer improved solubility.

### Example 4

### Effect Increasing Cation Concentration

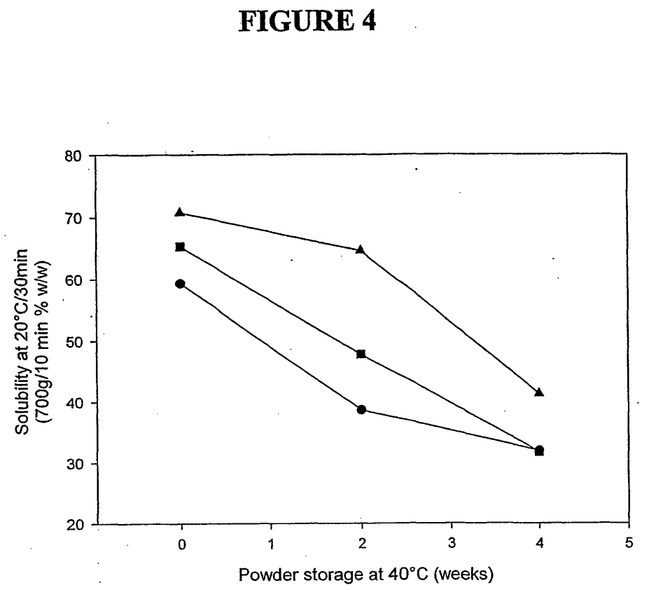

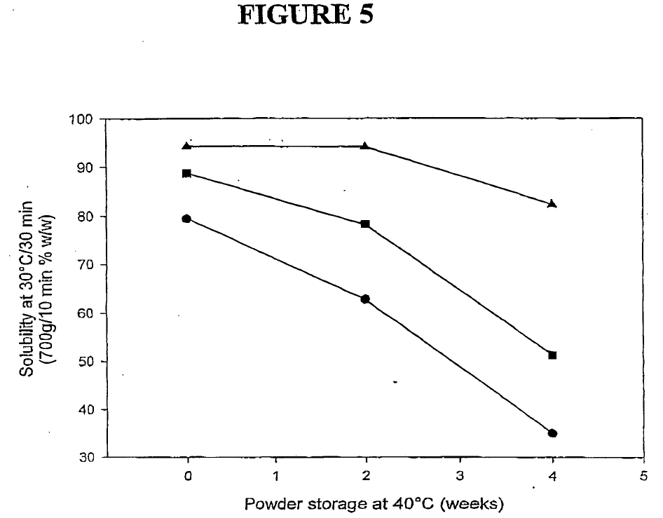

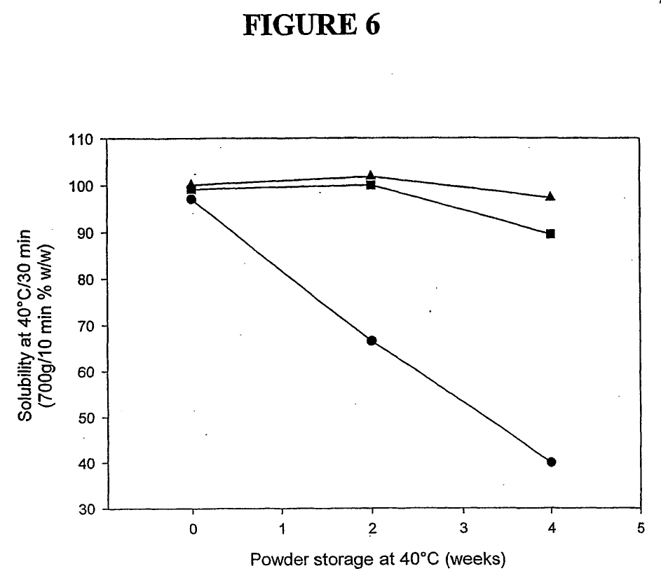

The experiments manufacturing MPC85 with added cations (refer Samples E,F and G-Table 1) show that the effect of cation addition is more pronounced with increasing cation concentration (FIGS. 4 to 6). At low cation concentration the effect on solubility in fresh powder is minimal but on storage these powders exhibit enhanced solubility, particularly at high temperatures. Powders with higher cation concentrations exhibit enhance solubility even mi fresh powder and at low temperatures.

### Example 5

### Cation—enhancement for MPC70

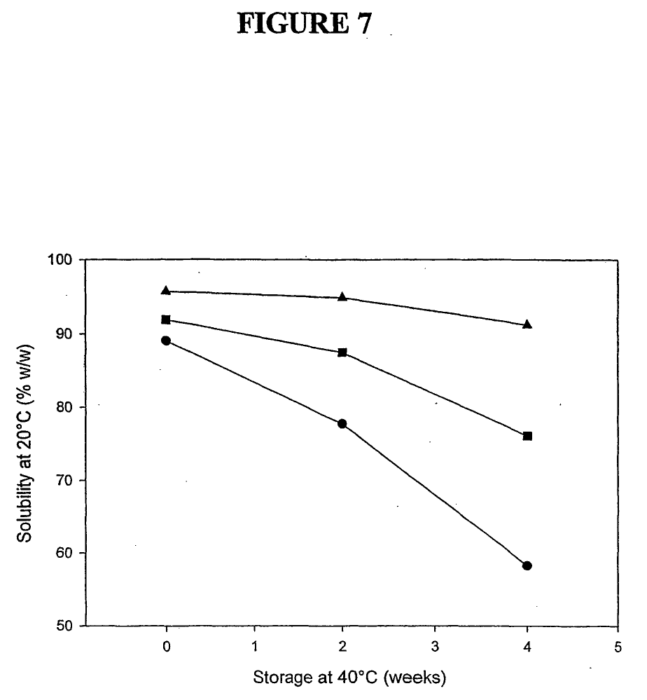

In this experiment sodium cations were added at two different levels to MPC70 retentate prior to drying (samples I and J-Table 1). A control powder (sample H-Table 1) with no added cations was also made with the same batch of retentate. The solubility at 20° C./storage stability profiles for these powders are shown in FIG. 7. As with cation addition to MPC85, the effect on solubility increases with storage time and with increasing cation concentration.

### Example 6

### Comparison of Different Monovalent Species

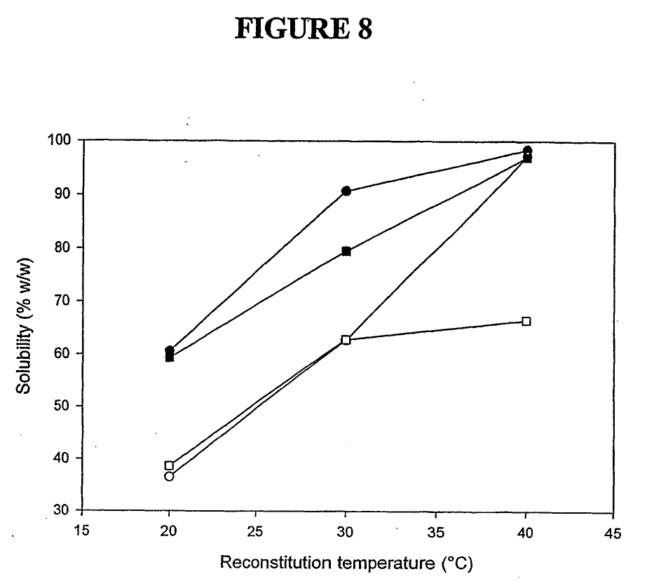

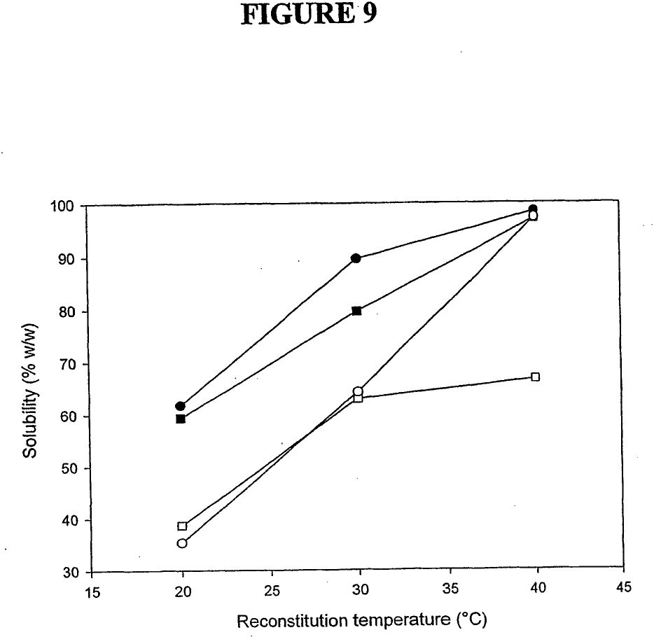

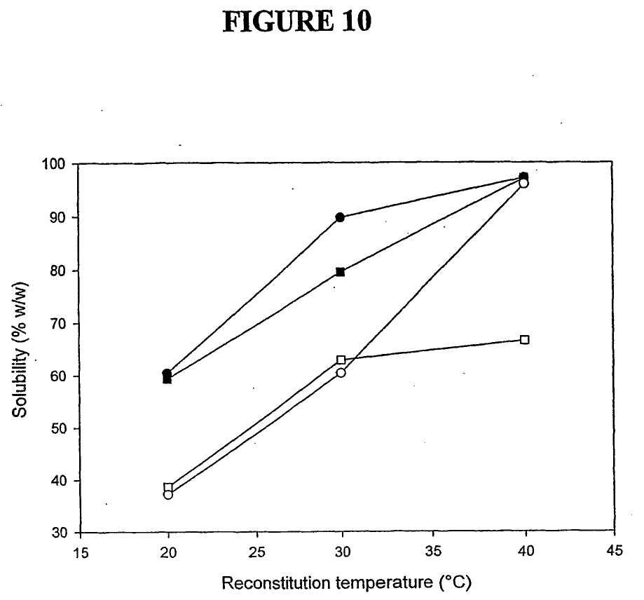

The positive effect of cation addition on enhancing the solubility of MPC is shown by comparison of the solubility storage figures (FIGS. 8 to 10) for sodium-enhanced (Table 1-sample K) and potassium-enhanced (Table 1-samples L and M) powders which have been made with the same molar addition of cation and the same mass of salt added per 100 g protein respectively. These figures show that different species of monovalent cations have very similar effects on the solubility/storage properties of MPC powders.

### Example 7

### Divalent Cation Addition

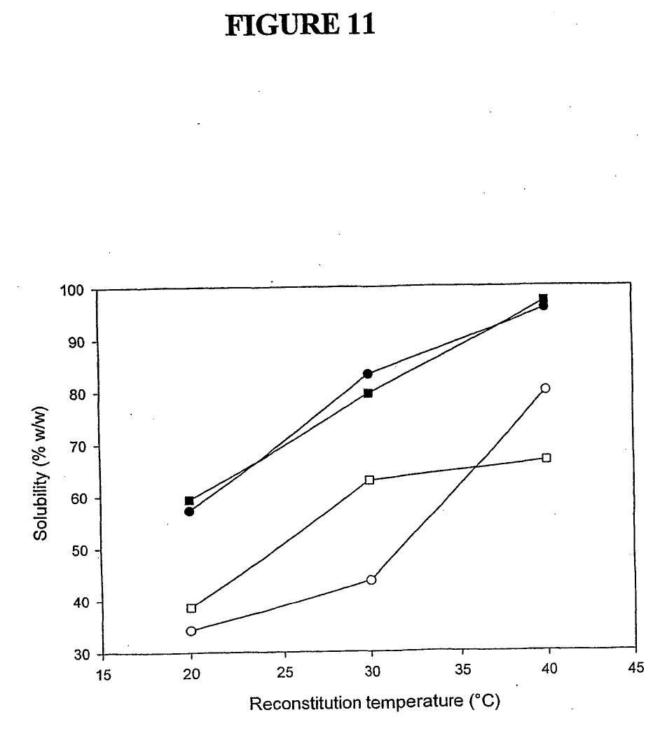

The solubility/storage profile (FIG. 11) for powder N (refer Table 1) shows that with the technology described here it is possible to add divalent cations, in combination with a monovalent cation, with no detrimental effect in the solubility of fresh powder reconstituted in water between 20 to 40° C. On storage at 40° C. the divalent enhanced powder shows improved solubility characteristics, when reconstituted at 40° C., over the control powder, The improved solubility characteristics were not see=at reconstitution temperatures of 20° C. nor 30° C.

### Example 8

### Conversion of Poor Powder to Good Powder

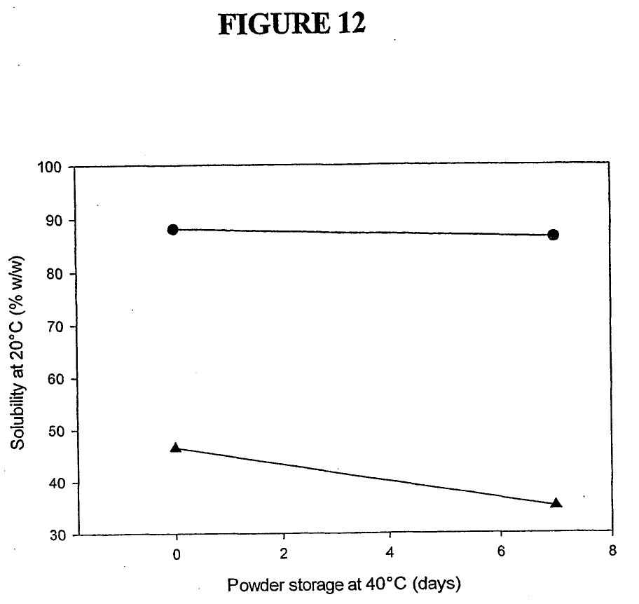

In this example a commercial MPC85 powder was reconstituted at 50° C., had sodium (0.081 moles/100 g protein) and potassium (0.14 moles/100 g protein) ions added (in the form of their chloride salts) and then re-dried to give a cation-enhanced powder (sample O in Table 1). FIG. 12 shows that compared to the base starting powder, the cation-enhanced powder was converted to an MPC powder with a significantly improved cold (20° C.) solubility profile. The solubility of the converted powder is 88% fresh and 87% after 7 days storage at40° C. compared to 46 and 35% solubility for the original powder respectively.

This example shows that application of the technology described here can convert old stock with poor solubility properties into powder with excellent solubility.

### Example 9

### Cheese Milk Extension

Four MPC samples with 85% milk protein were tested in cheese making. 3.47 kg of fresh skim milk containing 4.38% protein and 0.18% fat was the starting material Fresh cream (505grams) containing 2.06% protein and 41.2% fat was added under medium shear to the fresh skim milk previously brought to 32.5° C. The resulting milk solution contained 4.07% protein and 5.36% fat as determined by Milkoscan Analyses.

The milk solution was divided into four batches. To each batch a different MPC containing 85% protein was added. One batch received the fresh large scale control PC85 (sample D-Table 1), a second received a large scale control MPC85 (sample D-Table 1) that had been stored at 40° C. for 7 days. The third batch received the fresh large scale cation enhanced MPC85 (sample C-Table 1) and the fourth batch received large scale cation enhanced MPC85 (sample C-Table 1) stored at 40° C. for 7 days. The reconstitution was carried out at 4.5 to 8.5° C.

All powders dispersed into the milk in well. No problems were noticed with the powders lumping, not wetting or floating on top of the milk. The pH of all the reconstituted mills were similar with the pH between 6.5 to 6.6 when measured at 32.5° C.

Cheese manufacture was by a standard cheddar process. The rennet used was Australian DS. After two days the cheese preparations were examined. In the two cheese preparations to which control MPC85 (fresh and stored at 40° C.) many large grey translucent nuggets were obvious. The nuggets in the cheese preparation made from control MPC85 that had been stored at 40° C. for 7 days were larger and more numerous than those present in the cheese preparation made from the fresh control MPC85. The cheese preparations made from the cation-enhanced MPC85 both contained only a few very small strands of nugget material.

Observations made during the cheese making steps showed that the starters performed excellently in all the re-constituted milks and that the pH of all the milks dropped to 6.45 to 6.46 over the 15 minute incubation period. All the preparations formed a coagulum at 40 minutes after rennet was added. For all four samples the cooked curd character was excellent. None of the curds presented any problems during the salting and pressing steps.

When used for cheese extension applications the cation-enhanced MPC was judged to be a significant improvement, particularly when comparing the powders stored at 40° C. for 7 days, over the control MPC85.

The above examples are illustrations of the practice of the invention. It will be appreciated by those skilled in the art that the invention can be carried out with numerous modifications and variations. For example, the material subjected to the process can show variations in protein concentration and pH, and the timing of salt addition and drying procedures can be varied.

1. A method for preparing a dried enhanced-solubility milk protein concentrate (MPC) or milk protein isolate (MPI) product comprising:
(a) providing an MPI or MPC having at least 70% dry matter as milk protein in aqueous solution or suspension;
(b) adding at least one monovalent salt in an amount that confers enhanced solubility on the product when dried; and
(c) drying the product;
wherein the addition of the monovalent salt adds 0.013-0.30 moles of cation per 100 g protein.

2. A method for preparing a dried enhanced-solubility milk protein concentrate (MPC) or milk protein isolate (MPI) product comprising:
(a) providing a skim milk in the form of an aqueous solution or suspension;
(b) adding at least one monovalent salt;
(c) concentrating the solution obtained by ultrafiltration, to form an MPI or MPC having at least 70% dry weight as protein; and
(d) drying to prepare a dried product with enhanced solubility; wherein the addition of the monovalent salt adds 0.013-0.30 moles of cation per 100 g protein.

3. A method of preparing a dried enhanced-solubility milk protein concentrate (MPC) or milk protein isolate (MPI) comprising:
(a) providing skim milk in the form of an aqueous solution or suspension;
(b) concentrating the skim milk by ultrafiltration, with diafiltration, to form an MPI or MPC having at least 70% dried weight as protein;
(c) drying to prepare a dried product with enhanced solubility;
wherein the diafiltration medium comprises at least one monovalent salt and the MPC or MPI formed contains 0.013-0.30 moles of added cation per 100 g protein.

4. A method for preparing a dried enhanced-solubility milk protein concentrate (MPC) or milk protein isolate (MPI) comprising:
(a) providing an MPI or MPC having at least 70% dry matter as milk protein in aqueous solution or suspension;
(b) removing part of the water from the MPC or MPI;
(c) adding to the concentrated MPC or MPI at least one monovalent salt in an amount that confers enhanced solubility on the product;
(d) drying the product;
wherein the addition of the monovalent salt adds 0.01-0.30 moles of cation per 100 g protein.

5. A method as claimed in claim 4 wherein the dewatering step is an evaporation step.

6. A method as claimed in claim 1 wherein the salt is a potassium or sodium salt.

7. A method as claimed in claim 6 wherein the salt is sodium chloride.

8. A method as claimed in claim 1 wherein at least one divalent salt is added prior to the drying step.

9. A method as claimed in claim 8 wherein the divalent salt is a calcium salt.

10. A method as claimed in claim 1 wherein 0.035-0.25 moles of cation is added per 100 g protein.

11. A method as claimed in claim 10 wherein 0.035-0.10 moles of cation is added per 100 g protein.

12. A method as claimed in claim 1 wherein the MPI or MPC in aqueous solution or suspension is formed by reconstituting a dried MPI or MPC at a temperature sufficient to solubilize it.

13. A dried enhanced solubility MPC or MPI produced by a method as claimed in claim 1.

14. A dried MPC or MPI having at least 70% dried weight as protein comprising 0.013-0.30 moles of added monovalent cation per 100 g protein, said monovalent cation having been added prior to drying.

15. A method of cheese manufacture wherein the milk starting material is extended with a dried MPC as claimed in claim 13.

16. The method of claim 2, wherein the solution is concentrated with diafiltration.
